(19) United States
(12) Patent Application Publication
(10) Pub. No.: US 2019/0012024 A1
(43) Pub. Date: Jan. 10, 2019

(54) DISPLAY SUBSTRATE AND DISPLAY DEVICE

(71) Applicants: BOE TECHNOLOGY GROUP CO., LTD., Beijing (CN); HEFEI XINSHENG OPTOELECTRONICS TECHNOLOGY CO., LTD., Hefei, Anhui (CN)

(72) Inventors: Xinbin Tian, Beijing (CN); Ming Zhang, Beijing (CN); Tsungchieh Kuo, Beijing (CN); Jian Tian, Beijing (CN); Shifeng Xu, Beijing (CN); Yu Zhu, Beijing (CN); Chunjian Liu, Beijing (CN); Qitao Zheng, Beijing (CN); Zouming Xu, Beijing (CN)

(73) Assignees: BOE TECHNOLOGY GROUP CO., LTD., Beijing (CN); HEFEI XINSHENG OPTOELECTRONICS TECHNOLOGY CO., LTD., Hefei, Anhui (CN)

(21) Appl. No.: 15/745,005

(22) PCT Filed: Aug. 9, 2017
(86) PCT No.: PCT/CN2017/096630

§ 371 Date: Jan. 15, 2018

(30) Foreign Application Priority Data
Jan. 22, 2017 (CN) 201710047180.2

(51) Int. Cl. G06F 3/041; G06F 3/044; G02B 5/20; G02B 5/30

(52) U.S. Cl. CPC G06F 3/0412; G06F 3/044; G06F 3/0414; G02B 5/3025; G02B 5/201

(57) ABSTRACT

A display substrate and a display apparatus are disclosed in the field of display technology. The display substrate is used for forming a touch panel by being disposed against an array substrate. The display substrate includes an aligned substrate, a cover plate disposed opposite to the aligned substrate, and multiple touch units. Each touch unit includes a first electrode disposed in the aligned substrate and a second electrode disposed on a side of the cover plate close to the aligned substrate. A control unit is further included and configured to detect a feedback signal of the first electrode of each touch unit in order to determine the touch point position and the pressure magnitude. The first electrode is formed on the aligned substrate while the second electrode is formed on the cover plate.

### CROSS-REFERENCE TO RELATED APPLICATION

This application claims priority of the Chinese Patent Application No. 201710047180.2, filed on Jan. 22, 2017, the disclosure of which is incorporated herein by reference in its entirety.

### TECHNICAL FIELD

This disclosure relates generally to a display technology, and more particularly relates to a display substrate and a display device.

### BACKGROUND

The touch screen has become a major human-computer interaction means for personal mobile communication devices and integrated information terminals such as tablet PCs, smart phones, and super notebook computers, due to its ease of operation, intuition, and flexibility. Touch screens can be divided into four major categories including resistive touchscreen, capacitive touch screen, infrared touch screen, and surface acoustic wave (SAW) touch screen. Among them, the capacitive touch screen features multi-touch function, fast response time, long life expectancy, and high light transmittance, leading to superior user experience. In addition, with the gradual maturity of the manufacturing process, the rate of qualified products going out of the factory has been significantly improved and the prices of capacitive screens have increasingly fallen. For that reason, the capacitive screen has become the primary touch interactive technology used by small and medium size information terminals.

However, the current process for manufacturing force touch sensors is relatively complex and expensive. Only high-end electronic products can afford to adopt the force touch sensors. It is desirable to provide a touch screen incorporating pressure sensors.

### SUMMARY

The present disclosure is directed to at partially solving or alleviating at least one of the technical problems present in the prior art and thus providing a display substrate and a display device equipped with pressure touch function.

Embodiments of the disclosure provide a display substrate for force-sensing. The display substrate includes a first substrate; a cover plate opposite to the first substrate; a plurality of touch first for force-sensing, wherein at least one of the plurality of touch units comprises a first electrode on a side of the first substrate close to the cover plate and a second electrode on a side of the cover plate close to the first substrate; and a plurality of pressure transmission posts between the first substrate and the cover plate.

The first substrate comprises a first base and a common electrode layer on a side of the first base away from the cover plate.

The first electrode in the touch units and common electrodes in the common electrode layer have a same structure.

The display substrate further comprises a control unit configured to provide a common voltage signal for the common electrodes during a display phase, and provide a feedback signal used to detect the first electrode of each touch unit during a touch phase in order to determine a touch point position and a pressure magnitude.

The first substrate is a color filter substrate comprising a first base, a color filter layer on a side of the first base away from the cover plate, and a protective layer on a side of the color filter layer close to the array substrate.

The first electrode of each touch unit is between the color filter layer and the protective layer.

The first substrate further comprises a polarizer on a side of the first base away from the color filter layer.

The first electrode of each touch unit is between the first base and the polarizer.

The plurality of pressure transmission posts are disposed between the first substrate and the cover plate at positions corresponding to the touch units.

The second electrodes of the plurality of touch units constitute a plate electrode.

The first electrodes in the touch units and the common electrodes in the common electrode layer have a same structure. The display substrate further comprises a control unit configured to provide a common voltage signal for the common electrodes during a display phase, and provide a feedback signal used to detect the first electrode of each touch unit during a touch phase in order to determine a touch point position or a pressure magnitude.

The at least one touch unit comprises an Indium tin oxide (ITO) force touch sensor.

The plurality of pressure transmission posts are between a polarizer and the second electrode.

The color filter layer is between a first base and a protective layer.

A protective layer and the first electrode are above an array substrate.

In a second aspect, a display apparatus includes the display substrate as described above.

Another solution adopted by the disclosure is a display device comprising the display substrate as described above.

### BRIEF DESCRIPTION OF THE ACCOMPANYING DRAWINGS

FIG. 1 is a diagram illustrating a display substrate according to some embodiments of the disclosure.

FIG. 2 is a diagram illustrating a display substrate according to some embodiments of the disclosure.

FIG. 3 is a diagram illustrating a display substrate according to some embodiments of the disclosure.

FIG. 4 is a diagram illustrating another display substrate according to some embodiments of the disclosure.

FIG. 5 is a diagram illustrating a display device according to some embodiments of the disclosure.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various examples of the present disclosure. Also, common but well-understood elements that are useful or necessary in a commercially feasible example are often not depicted in order to facilitate a less obstructed view of these various examples. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above, except where different specific meanings have otherwise been set forth herein.

### DETAILED DESCRIPTION OF ILLUSTRATED EMBODIMENTS

The terminology used in the present disclosure is for the purpose of describing exemplary examples only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first.” “second,” “third,” etc. may be used herein to describe various information, the information should not be limited by these terms. These terms are only used to distinguish one category of information from another. For example, without departing from the scope of the present disclosure, first information may be termed as second information and similarly, second information may also be termed as first information. As used herein, the term “if” may be understood to mean “when” or “upon” or “in response to” depending on the context.

Reference throughout this specification to “one embodiment,” “an embodiment,” “exemplary embodiment.” or the like in the singular or plural means that one or more particular features, structures, or characteristics described in connection with an example is included in at least one embodiment of the present disclosure. Thus, the appearances of the phrases “in one embodiment” or “in an embodiment.” “in an exemplary embodiment.” or the like in the singular or plural in various places throughout this specification are not necessarily all referring to the same embodiment. Furthermore, the particular features, structures, or characteristics in one or more embodiments may be combined in any suitable manner.

The present disclosure will now be described in further detail with reference to the accompanying drawings and specific embodiments in order to provide a better understanding of the solutions of the disclosure by those skilled in the art.

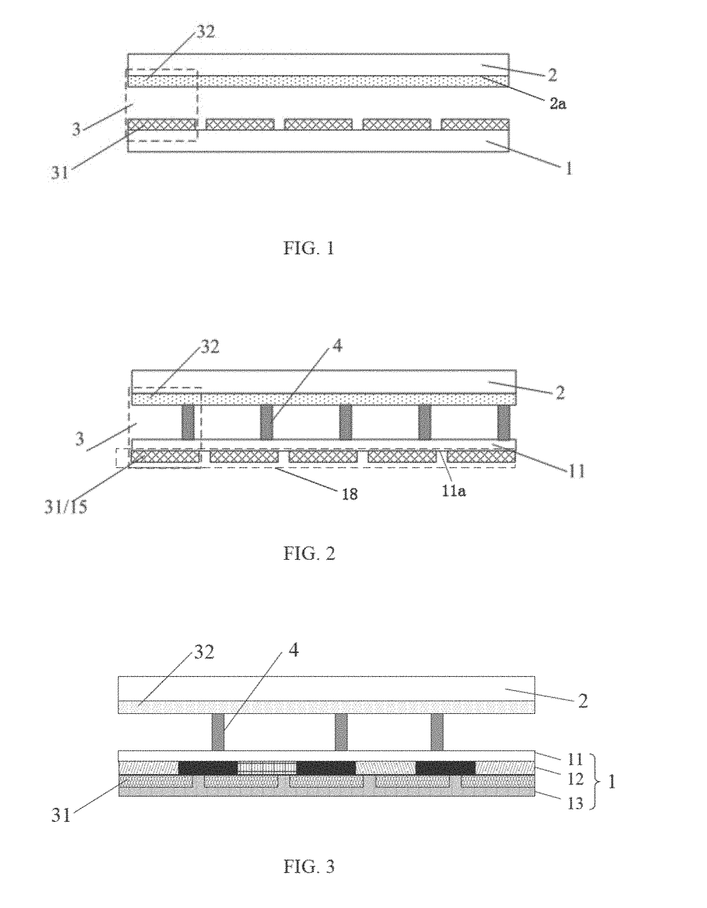

In some embodiments, as shown in FIG. 1, there is provided a display substrate which can be disposed against an array substrate to form a touch panel. Display substrate 1 may include a first substrate 1, a cover plate 2 disposed opposite to the first substrate 1, and a plurality of touch units 3. Each touch unit 3 may include a first electrode 31 disposed on the first substrate 1 and a second electrode 32 disposed on the side 2a of cover plate 2 close to the first substrate 1. As such, a feedback signal of first electrode 31 of each of touch units 3 is detectable by a control unit for determining the touch point position and/or the pressure magnitude.

For example, the touch unit 3 may include a Force Touch sensor into a conventional color filter (CF) Glass substrate, make a Force Touch sensor electrode layer using an Indium tin oxide (ITO) conductive layer in a conventional CF stack structure. Alternatively, the touch unit may use the Force Touch sensor electrode layer to cover on a CF RGB color layer. The touch unit may dispose the Force Touch sensor electrode layer on the polarizer (POL) of CF Glass. A layer of a comprehensive ITO may be disposed on the CG cover to work as a pressure touch capacitive reference layer. The distance between the pressure contact layer and the capacitance reference layer is changed by the elastic deformation of the glass cover when the pressure is introduced by a touch, and the capacitance of the pressure touch pattern changes. Thus, the IC determines the location and magnitude of the touch according to the capacitance of the pressure touch capacitor.

It should be noted that when the display substrate of this embodiment is aligned and engaged with the array substrate to form the touch panel, aligned substrate 1 may be installed against the array substrate.

In this embodiment, the display substrate includes a number of touch units 3. With the touch panel formed by aligning and binding the display substrate with the array substrate, the cover plate 2 of the display substrate may be deformed when a pressure contact occurs thereon and so the capacitance between first electrode 31 and second electrode 32 of touch unit 3 at the position where the pressure contact occurs may be changed. At this point, the control unit may detect a feedback signal from first electrode 31, which is related to the capacitance change of touch unit 3. For that reason, the feedback signal of first electrode 31 may also be changed. Thus, the feedback signal of first electrode 31 can be used to determine the position of the pressure touch and the pressure magnitude, where the latter can further be based on to execute a corresponding instruction. In addition, first electrode 31 is formed on aligned substrate 1 while second electrode 32 is formed on the cover plate 2; such a structure can be simple to manufacture and low in cost.

Referring now to FIG. 2, in a first exemplary implementation of the first embodiment, aligned substrate 1 of the display substrate may include a first base 11 and a common electrode layer 18 disposed on the side 11a of first base 11 away from cover plate 2. First electrodes 31 in touch units 3 and common electrodes 15 in the common electrode layer 18 may be the same structure. The display substrate may further include a control unit (not shown in the figure) configured to provide a common voltage signal (typically a pulse signal) for common electrodes 15 during a display phase, and provide a feedback signal used to detect first electrode 31 of each of touch units 3 during a touch phase in order to determine the touch point position and/or the pressure magnitude. That is, common electrodes 15 can be multiplexed during the display and touch phases. Such structure can be simple and comparatively lighter and thinner.

Second electrode 32 of each touch unit 3 may be disposed on a side 2a of cover plate 2 near first base 11. Typically, the plurality of second electrodes 32 may be integrally formed. That is, all of the second electrodes 32 may constitute an entire plate-like electrode. During the touch phase a reference voltage may be input to each of second electrodes 32. Now, if a pressure contact occurs on cover plate 2, the distance between first electrode 31 and the corresponding second electrode 32 may become narrowed at the position where the touch occurs, and the control unit may determine the location of the touch and the magnitude of the touch pressure according to the feedback signal from second electrode 32, and further may execute a corresponding instruction based on the pressure magnitude.

Typically, a plurality of pressure transmission posts 4 may be disposed between aligned substrate 1 and cover plate 2 at the locations corresponding to touch units 3. Each pressure transmission post 4 may transmit the pressure from second electrode 32 to first electrode 31 when a pressure touch occurs, so that the feedback signal received by first electrode 31 can be more sensitive, which further facilitates the determination of the touch point position and the pressure magnitude. Pressure transmission posts 4 may be provided on the side of the first base 11 remote from first electrodes 31 or may be provided on the side 2a of cover plate 2 near first base 11.

A second exemplary implementation of this embodiment is substantially the same as the above first exemplary implementation; only in the former aligned substrate 1 of the display substrate is a color filter substrate. In particular, referring to FIG. 3, the color filter substrate may include a first base 11, a color filter layer 12 disposed on first base 11, and a protective layer 13 provided on color filter layer 12. Typically, color filter layer 12 may be composed of color filters of different colors (e.g., a red filter, green filter, or blue filter) and a black matrix disposed between every two adjacent filters. First electrode 31 of each touch unit 3 may be disposed between color filter layer 12 and protective layer 13. Alternatively, first electrode 31 may be disposed between first base 11 and color filter layer 12, or disposed on the side of protective layer 13 remote from color filter layer 12.

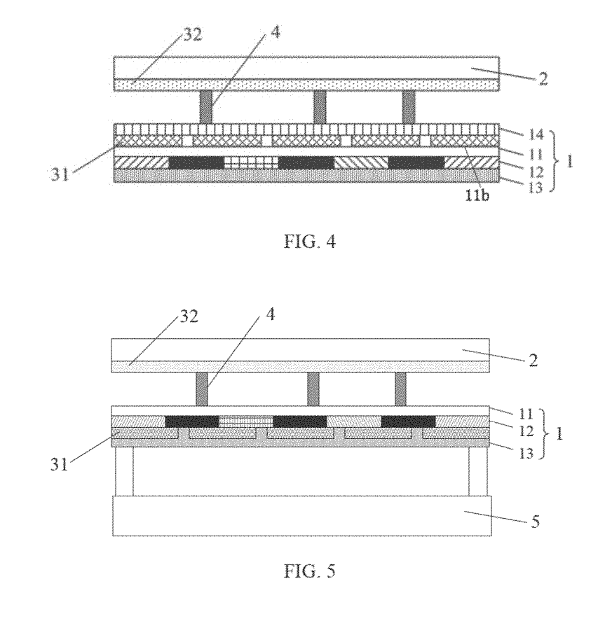

Referring now to FIG. 4, the display substrate further may include a polarizer 14 disposed on the side 11b of first base 11 away from color filter layer 12. Accordingly, first electrode 31 of each touch unit 3 may be disposed between first base 11 and polarizer 14, or disposed on the side of polarizer 14 remote from first base 11.

Second electrodes 32 of touch units 3 in the display substrate according to this implementation may be positioned in the same manner as in the first implementation. That is, second electrode 32 of each touch unit 3 may be disposed on a first side 2a of cover plate 2 near first base 11. Typically, the plurality of second electrodes 32 may be integrally formed. That is, all second electrodes 32 may constitute an entire plate-like electrode.

The display substrate according to the second exemplary implementation described above differs from that according to the first exemplary implementation only in the positions where first electrodes 31 are disposed, the operating principles of which are the same and so are not to be repeatedly detailed herein.

Both first electrode 31 and second electrode 32 of each touch unit may be of a transparent conductive material such as indium tin oxide (ITO), indium gallium tin oxide (IGZO), and the like.

In some embodiments, referring now to FIG. 5, there is provided a display device that includes the display substrate of Embodiment 1, and the display device further may include an array substrate 5 disposed against the display substrate.

When the display substrate of the display device is implemented as the display substrate according to the first exemplary implementation of Embodiment 1, array substrate 5 typically may be one incorporating a color filter layer 12, namely a COA (Color Filter On Array) substrate. Otherwise if the display substrate of the display device is implemented as that according to the second exemplary implementation of Embodiment 1, i.e., the display substrate is a color filter substrate, then array substrate 5 can be implemented as one known to those skilled in the art.

In this embodiment, the display device employs the display substrate of Embodiment 1, where the display substrate includes a number of touch units 3. With a touch panel formed by aligning and binding the display substrate with the array substrate, the cover plate 2 of the display substrate may deform when a pressure contact occurs thereon and so the capacitance between first electrode 31 and second electrode 32 of touch unit 3 at the position where the pressure contact occurs may be changed. At this point, the control unit may detect a feedback signal from first electrode 31, which is related to the capacitance change of touch unit 3. For that reason, the feedback signal can be used to determine the position of the pressure touch and the pressure magnitude, where the latter can further be based on to execute the corresponding instructions. In addition, first electrode 31 is formed on aligned substrate 1 while second electrode 32 is formed on the cover plate 2; such a structure can be simple to manufacture and low in cost.

The display device according to this embodiment may be any display product or component built in with display function such as a liquid crystal panel, an organic light-emitting diode (OLED) panel, an electronic paper, a mobile phone, a tablet computer, a television set, a monitor, a notebook computer, a digital photo frame, a navigator, or the like.

Advantages of the present disclosure may follow. The display substrate includes a number of touch units. With a touch panel formed by aligning and binding such a display substrate with an array substrate, the cover plate of the display substrate can be deformed when a pressure contact occurs thereon and so the capacitance between the first electrode and the second electrode of the touch unit at the position where the pressure contact occurs may be changed. At this point, the control unit may detect a feedback signal from the first electrode, which is related to the amount of change of the capacitance of the touch unit, namely the “capacitance change” for short. For that reason, the feedback signal can be used to determine the position of the pressure touch and the pressure magnitude, where the latter can further be based on to execute a corresponding instruction. In addition, the first electrode is formed on the aligned substrate while the second electrode is formed on the cover plate; such a structure can be simple to manufacture and low in cost.

It is to be understood that the foregoing description merely depicts some exemplary embodiments of the disclosure for the sole purpose of illustrating the principles of the disclosure, but the disclosure is not limited thereto. It would be apparent to those skilled in the art that various changes and modifications can be made therein without departing from the spirit and scope of the disclosure, and all these changes or modifications shall be considered to fall within the protection of the disclosure.

1. A display substrate for force-sensing, comprising:
a first substrate;
a cover plate opposite to the first substrate;
a plurality of touch units for force-sensing, wherein at least one of the plurality of touch units comprises a first electrode on a side of the first substrate close to the cover plate and a second electrode on a side of the cover plate close to the first substrate; and
a plurality of pressure transmission posts between the first substrate and the cover plate.

2. The display substrate according to claim 1, wherein the first substrate comprises a first base and a common electrode layer on a side of the first base away from the cover plate.

3. The display substrate according to claim 2, wherein the first electrode in the touch units and common electrodes in the common electrode layer have a same structure.

4. The display substrate according to claim 3, wherein the display substrate further comprises a control unit configured to provide a common voltage signal for the common electrodes during a display phase, and provide a feedback signal used to detect the first electrode of each touch unit during a touch phase in order to determine a touch point position and a pressure magnitude.

5. The display substrate according to claim 1, wherein the first substrate is a color filter substrate comprising a first base, a color filter layer on a side of the first base away from the cover plate, and a protective layer on a side of the color filter layer close to the array substrate.

6. The display substrate according to claim 5, wherein the first electrode of each touch unit is between the color filter layer and the protective layer.

7. The display substrate according to claim 4, wherein the first substrate further comprises a polarizer on a side of the first base away from the color filter layer.

8. The display substrate according to claim 7, wherein the first electrode of each touch unit is between the first base and the polarizer.

9. The display substrate according to claim 1, wherein the plurality of pressure transmission posts are disposed between the first substrate and the cover plate at positions corresponding to the touch units.

10. The display substrate according to claim 1, wherein the second electrodes of the plurality of touch units constitute a plate electrode.

11. The display substrate according to claim 2, wherein the first electrodes in the touch units and the common electrodes in the common electrode layer have a same structure; the display substrate further comprises a control unit configured to provide a common voltage signal for the common electrodes during a display phase, and provide a feedback signal used to detect the first electrode of each touch unit during a touch phase in order to determine a touch point position or a pressure magnitude.

12. The display substrate according to claim 1, where the at least one touch unit comprises an Indium tin oxide (ITO) force touch sensor.

13. The display substrate according to claim 1, wherein the plurality of pressure transmission posts are between a polarizer and the second electrode.

14. The display substrate according to claim 1, further comprising a color filter layer between a first base and a protective layer.

15. The display substrate according to claim 1, wherein a protective layer and the first electrode are above an array substrate.

16. A display apparatus comprising the display substrate according to claim 1.
